(19) United States
(12) Patent Application Publication
(10) Pub. No.: US 2004/0145424 A1
(43) Pub. Date: Jul. 29, 2004

(54) Switchable circulator

(76) Inventor: Ronald William Jocher, East Hanover, NJ (US)

Correspondence Address: HARNESS, DICKEY & PIERCE, P.L.C., P.O. Box 8910, Reston, VA, 20195, US

(21) Appl. No.: 10/348,899

(22) Filed: Jan. 23, 2003

(51) Int. Cl. H01P 1/38

(52) U.S. Cl. 333/1.1; 333/24.2

(57) ABSTRACT

A circulator includes: a conductive launching disk; at least two ferrite disks sandwiched about the launching disk; and at least two electromagnets (e.g., flat coils) sandwiched about the ferrite disks. Such a circulator can be used with a controller to selectively: control current flow through the electromagnets so as to induce through the launching disk a first magnetic field (resulting in a first direction of rotation) or a second magnetic field, substantially opposite to the first field (resulting in a second direction of rotation opposite the first rotation direction); and/or substantially prevent current flow through the electromagnets (substantially preventing rotation). A corresponding switching system includes: at least a first device, a second device and a third device; a selectively reversible circulator having at least three ports connected to the first, second and third devices, respectively; and a controller operable to change the rotation exhibited by the circulator.

### BACKGROUND OF THE INVENTION

A circulator can be a ferrite device, i.e., a device that includes ferrite material. A typical ferrite component can include a compound of iron oxide with impurities of other oxides added. The iron oxide retains the ferromagnetic properties of the iron atoms while the impurities represented by the other oxides increase the ferrite's resistance to current flow. In contrast, elemental iron has good magnetic properties but a very low resistance to current flow. Such low resistance causes eddy currents and significant power losses at high frequencies. Ferrites, on the other hand, have sufficient resistance to be classified as semiconductors.

The magnetic property of any material is a result of electron movement within the atoms of the material. The two basic types of electron motion are the more familiar orbital motion (of the electron around the nucleus of the atom) and the less familiar electron spin (movement of the electron about its own axis). Magnetic fields are generated by current flow. The magnetic fields caused by the spinning electrons spin combine to give a material magnetic properties. In most materials, the spin axes of the electrons are so randomly arranged that the magnetic fields largely cancel out and the material displays no significant magnetic properties. But within some materials, such as iron and nickel, the electron spin axes can be caused to align by applying an external magnetic field. The alignment of the electrons within a material causes the magnetic fields to add together with the result that the material exhibits magnetic properties.

In the absence of an external force, the axis of spinning electrons tend to remain pointed in one direction. Once aligned, the electrons tend to remain aligned even when the external field is removed. Electron alignment in a ferrite is caused by the orbital motion of the electrons about the nucleus and the force that holds the atom together, i.e., binding forces. When a static magnetic field is applied to the ferrite material, the electrons try to align their spin axes with the external magnetic force. The attempt of the electrons to balance between the external magnetic force and the binding forces causes the electrons to wobble on their axes. The useful magnetic properties of a ferrite is based upon the behavior of the electrons under the influence of an external field and the resulting wobble frequency.

Reciprocity is a term generally used to describe the transformation of a signal by a device. Fundamentally, if a signal S1 is input to a terminal T1 of a device and a signal S2 is output at a terminal T2 of the device, then the device is considered to be reciprocal if inputting a signal S2 at terminal T2 of the device yields the signal S1 on terminal T1 of the device. Ferrite devices are non-reciprocal devices. Such non-reciprocity is based upon Faraday rotation, in which a linearly polarized plane wave propagating through the ferrite material undergoes a rotation of its polarized direction independently of whether it is propagating in a forward or backward direction if the frequency of the propagating wave is much greater than the wobble frequency.

Hence, a circulator is more appropriately described as a non-reciprocal ferrite device. The cross-section of a ferrite device according to the Background Art is depicted in FIG. 1A. There, a circulator 100 includes a conductive launching disk 102 having terminals 104₁, 104₂, and 104₃. Above and below the launching disk 102 are located ferrite disks 106A and 106B, respectively. Above the ferrite disks 106A and 106B are located permanent magnets 108A and 108B, respectively. The operation of the circulator 100 will be described in terms of corresponding FIGS. 1B and 1C.

FIG. 1B is the circuit diagram symbol for the circulator 100 of FIG. 1A. The circulator 100 provides unique transmission paths, allowing RF, energy to pass in one direction (namely the rotation direction 110) with little (insertion) loss, but with a high loss (isolation) in the opposite (counter-clockwise) direction. The direction of rotation is determined according to the direction (perpendicular or anti-perpendicular) of the static magnetic field induced through the launching disk 102 by the permanent magnets 108A and 108B.

The direction of rotation 110 in FIG. 1B is clockwise. As depicted in FIG. 1C, if a signal is input to the circulator 100 at terminal 104₁, then the signal will come out at terminal 104₂. If a signal is input at terminal 104₂, then the signal will come out at terminal 104₃. And if a signal is input at terminal 104₃, then the signal will come out at terminal 104₁.

If one of the terminals, e.g., 104₃, is terminated with an impedance-matched load, then the circulator 100 functions as an isolator. The loaded terminal absorbs the energy passing to it from terminal 104₂. Hence, in the use of three-terminals, the isolator acts as a device that passes energy in one direction (terminal 104₁ to 104₂) but not in the opposite direction.

A circulator/isolator can be constructed with more terminals, though a typical number of terminals is 3 or 4.

FIGS. 2A-2F are three-quarter perspective views of a known circulator, namely the FERROCOM 9A 59-31 model of circulator made available by the ALCATEL CORP in successive stages of being disassembled. The circulator 200 includes a magnetically conductive outer casing or pole structure 202 and coaxial cable connector structures 204₁ 204₂ and 204₃. In FIG. 2B, the pole structure 202 has been removed. This reveals non-magnetic spacer elements 206A and 206B, which are mirror images of each other. Also revealed is a permanent magnetic 208A of a rare earth material. The magnet 208A sits in a recess 210A (see FIG. 2C) within the spacer 206A. While obscured (and so not depicted) in FIG. 2B, the spacer 206B includes a permanent magnet 208B corresponding to magnet 208A. The magnet 208B (not depicted) is disposed in a recess 210B (not depicted) in the spacer 206B, where recess 210B corresponds to recess 210A.

In FIG. 2D, the spacer 206A has been removed. This reveals a ferrite disk 212A disposed directly underneath the permanent magnetic 208A (not depicted in FIG. 2D). Also shown in FIG. 2D are non-conductive spacer blocks 214 and non-conductive adhesive material 216. The block 214 are used to displace the spacer element 206A from the spacer element 206B. A corresponding ferrite disk 212B is depicted in FIG. 2D. In FIG. 2E, the ferrite disk 212A has been removed, revealing a shamrock-shaped launching disk 218. The ferrite disk 212B is visible beneath the launching disk 218.

In FIG. 2F, the spacer element 206B has been removed. This permits closer inspection of the launching disk 218. In addition, most of the coaxial connector structures 204₂ and 204₃ have been removed. Connected to the launching disk 218 are matching sections 220 of well known configuration. Between the launching disk 218 and the matching sections 220 are precisely shaped air gaps 222 that provide capacitance and inductance for impedance matching. Typically, the launching disk 218 and the matching sections 220 are made of copper.

Circulators (and isolators) according to the Background Art only exhibit rotation in one direction.

### SUMMARY OF THE INVENTION

The invention, also in part, is a recognition that a circulator can exhibit two directions of rotation if the direction of the magnetic field that biases the launching disk can be reversed.

The invention, also in part, is a recognition that: the ability to reverse the direction of the magnetic field that biases the launching disk in a circulator can be achieved by substituting electromagnets, e.g., coil-type electromagnets, for permanent magnets in a circulator; and substantially removing current flow from the electromagnets can induce substantially no rotation through the circulator, i.e., can substantially isolate all of the ports on the circulator from one another.

The invention, also in part, is a recognition that a switchable circulator, i.e., a circulator whose rotation direction can be changed, can have many more uses within a circuit in contrast to the uni-directional circulator according to the Background Art.

Additional features and advantages of the invention will be more fully apparent from the following detailed description of example embodiments, the appended claims and the accompanying drawings.

### BRIEF DESCRIPTION OF THE DRAWINGS

The accompanying drawings are: intended to depict example embodiments of the invention and should not be interpreted to limit the scope thereof; and not to be considered as drawn to scale unless explicitly noted.

FIG. 1A is a cross-sectional diagram of a uni-directional circulator according to the Background Art.

FIG. 1B is a diagram of the circuit symbol corresponding to the uni-directional circulator of FIG. 1A. FIG. 1C is a version of FIG. 1B modified to help explain the operation of a unit-directional circulator according to the Background Art.

FIGS. 2A-2F are three-quarter perspective views of a uni-directional circulator according to the Background Art in various stages of being dismantled, which cumulatively reveals the components as the Background Art uni-directional circulator.

FIG. 3 is a three-quarter perspective diagram of a switchable circulator according to an embodiment of the invention.

FIG. 4A is a cross-sectional diagram of the embodiment of FIG. 3.

FIG. 4B is a circuit diagram symbol corresponding to the embodiment of FIG. 3.

FIGS. 4C and 4D are versions of FIG. 4B that help explain the operation of the embodiment of FIG. 3.

FIGS. 5, 6 and 7 are application circuit example embodiments according to the invention.

### DETAILED DESCRIPTION OF EXAMPLE EMBODIMENTS

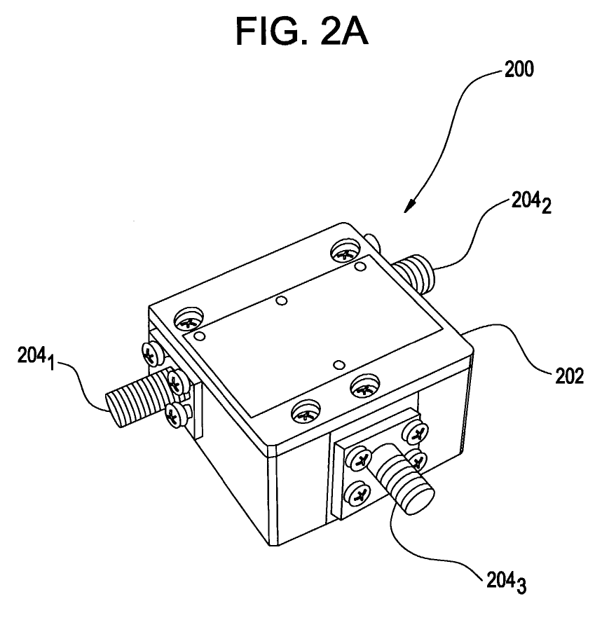

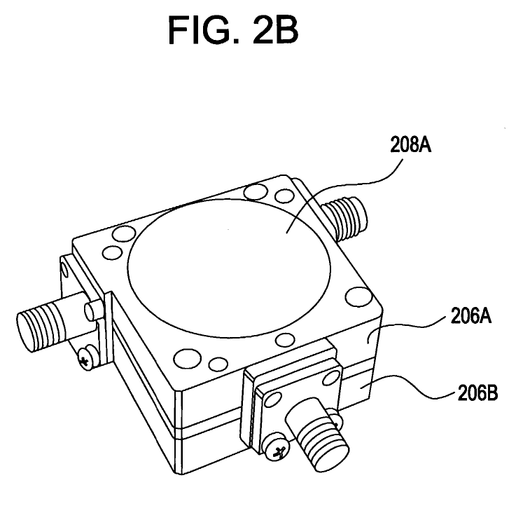

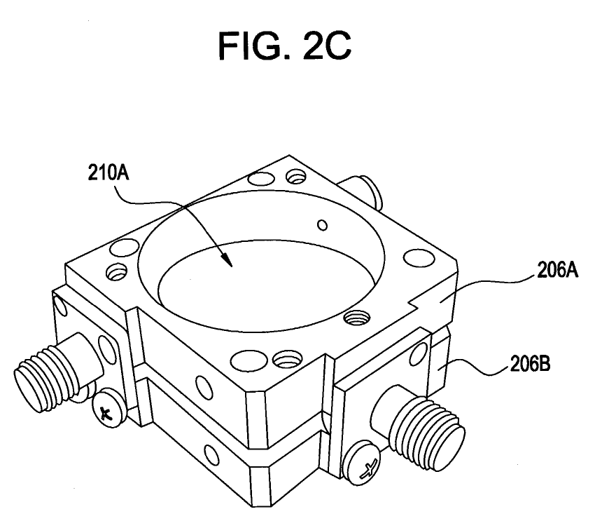

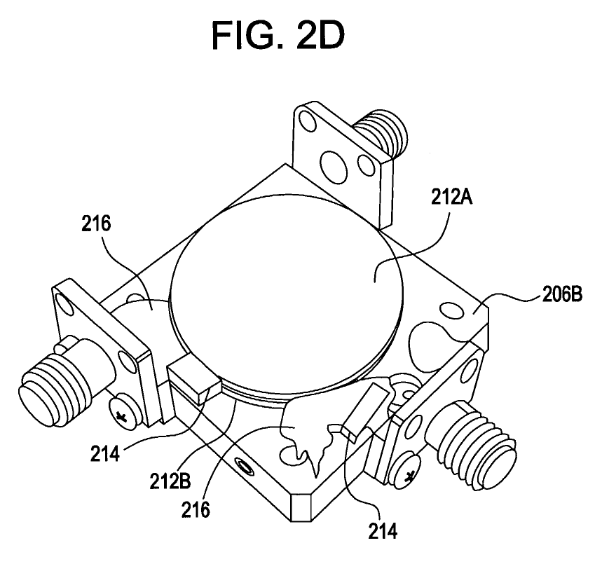

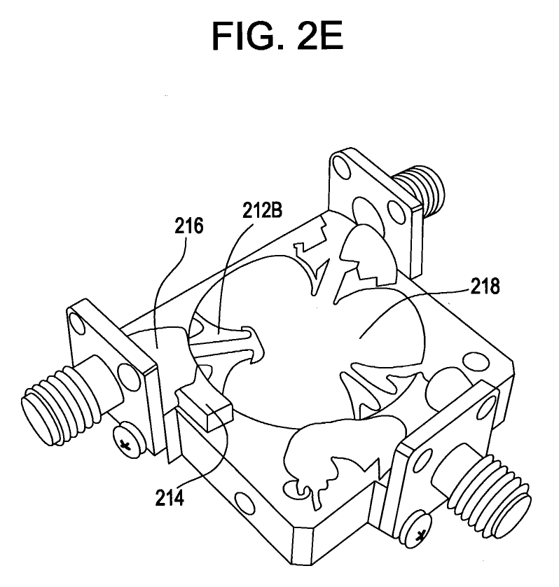

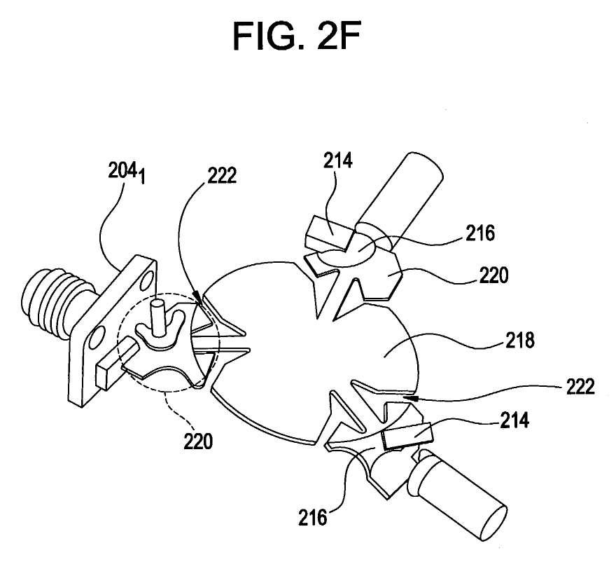

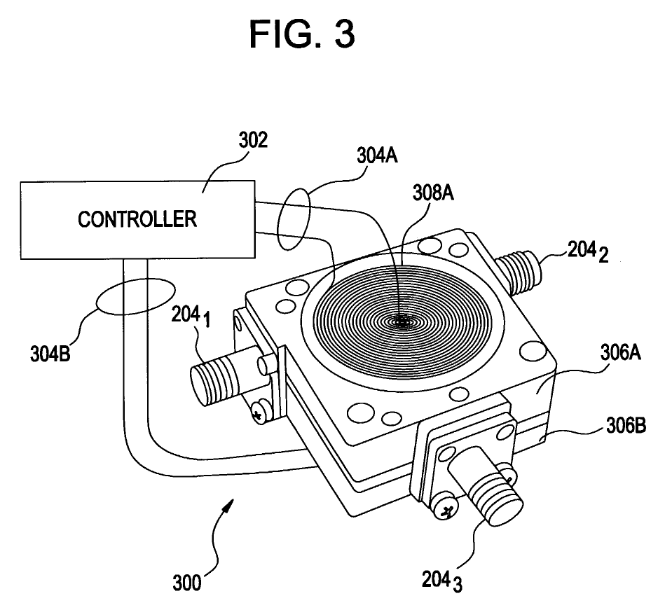

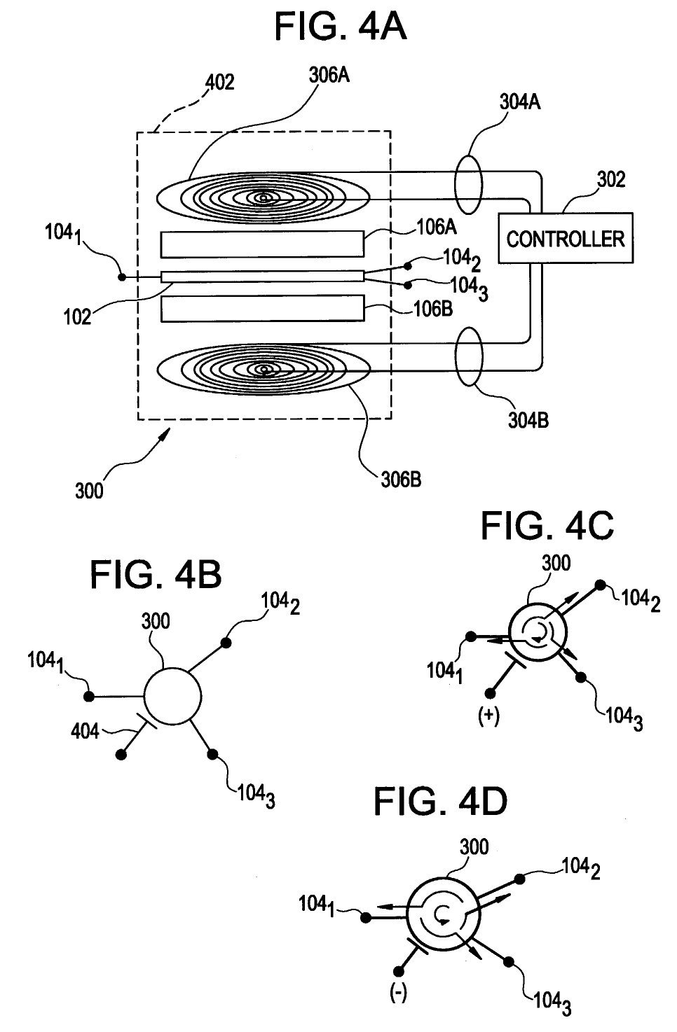

A simple embodiment of a circulator according to the invention is the modification of a unidirectional circulator according to the Background Art in which the permanent magnets have been replaced with electromagnets. FIG. 3 depicts a three-quarter perspective view of a circulator according to an embodiment of the invention. FIG. 3 corresponds to FIG. 2B except that the permanent magnets 208A and 208B (not depicted) have been replaced by electromagnets, e.g., coil-type electromagnets, 308A and 308B (obscured in FIG. 3, so not depicted). In addition, while spacer blocks 306A, 306B and pole structure 402 (see FIG. 4A) correspond to spacer blocks 206A, 206B and pole structure 202, the spacer blocks 306A, 306B and/or the pole structure 402 have been modified to accommodate the leads 304A and leads 304B that connect the coils 308A, 308B to a controller 302. Otherwise, the components included in the circulator 300 according to an embodiment of the invention (shown partially dismantled in FIG. 3) correspond to the components depicted in FIGS. 2A-2F.

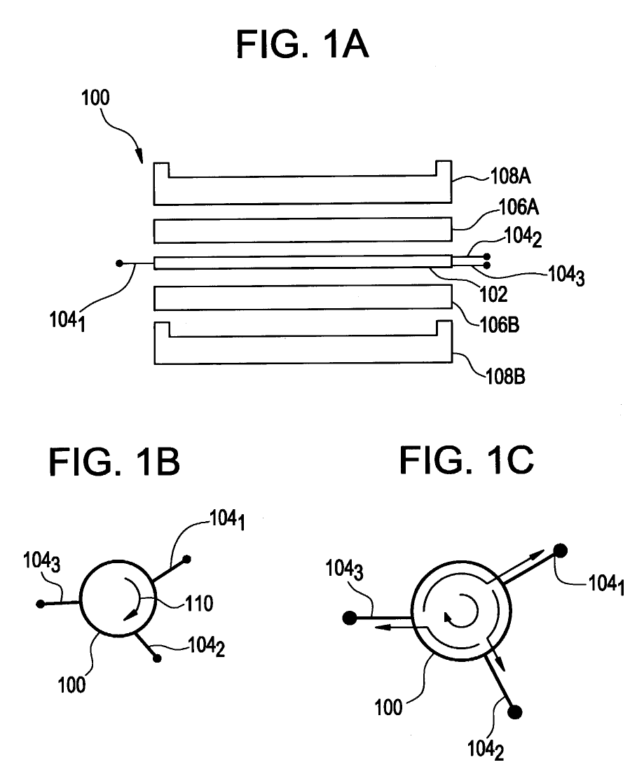

FIG. 4A is a cross-sectional diagram of the switchable circulator 300 of FIG. 3. Again, certain components correspond very closely, or are the same (and so use the same reference numbers), as those depicted in Background Art FIGS. 1A and 2A-2F.

The circulator 300 includes a launching disk 102 having terminals 104₁, 104₂ and 104₃. But it is noted that the launching disk 102 can be configured to have any number of terminals, although three terminals or four terminals are anticipated as being the typical number of terminals. The circulator 300 also includes ferrite disks 106A and 106B of known composition and manufacture, positioned above and below the launching disk 102, respectively. A flat coil electromagnetic 306A is positioned on the opposite side of the ferrite disk 106A relative to the launching disk 102. Another flat coil electromagnetic 306B is positioned on the other side of the ferrite disk 106B relative to the launching disk 102. Ends 304A of coil 306A, and ends 304B of coil 306B are connected to the controller 302.

The controller 302 can be a microprocessor and/or discreet logic elements and/or other circuit components. As an alternative to the flat coil-type electromagnets 306A, 306B, and electromagnetic (not shown) in the form of a coil wound along a metal rod could be used.

FIG. 4B is a circuit diagram symbol representing the circulator 300 . The symbol depicted in FIG. 4B is similar to the symbol depicted in FIG. 1B except for two differences: no arrow representing direction of rotation is depicted (because the direction of rotation is switchable); and a biasing terminal 404 is depicted to emphasize the switchable rotation aspect. FIGS. 4C and 4D are versions of FIG. 4B that help explain the operation of the circulator 300.

In FIG. 4C, a magnetic field in a first direction, e.g., the upward direction relative to FIG. 4A (substantially perpendicular to launching disk 102), has been induced by the flat coils 306A, 306B through the launching disk 102. The upward magnetic field is denoted by the plus symbol (+) in FIG. 4C. The effect is to induce clockwise rotation in the circulator 300. In this state, the circulator 300 behaves like a uni-directional circulator according to the Background Art.

In FIG. 4D, the opposite (namely, downward) magnetic field (substantially anti-perpendicular) through the launching disk 102 has been induced by the flat coil magnets 306A, 306B. This is depicted in FIG. 4D by the minus symbol (−). The result is that counter-clockwise rotation is induced in the circulator 300. In this state, the circulator 300, again, behaves like a unit-directional circulator according to the Background Art except that the rotation exhibited is opposite to the rotation exhibited in FIG. 4C. In FIGS. 4C and 4D, the insertion loss and isolation, respectively, between the ports is comparable to a uni-directional circulator according to the Background Art.

In FIG. 4B, if no current is supplied to the electromagnets 306A, 306B, the result is isolation between all the ports, i.e., no rotation. Furthermore, the isolation between the ports is greater under the no-rotation state than in the rotational states depicted in FIGS. 4C and 4D.

There are transition periods during which the electromagnets 306A, 306B are initially energized with current, or current through the electromagnets 306A, 306B is substantially stopped, or the flow of current through the electromagnets 306A, 306B is changed in direction/polarity to cause changes in the associated field direction. During the transition periods, the fields induced by the electromagnets 306A, 306B vary substantially. Apart from the transition periods, the equilibrium current sourced by the controller 302 to the electromagnets 306A, 306B is substantially constant, resulting in the fields induced by the electromagnets 306A, 306B settling down to be substantially static. In the alternative, the controller 302 can be configured to apply a dynamic waveform to the electromagnets 306A, 306B.

In FIG. 4A, the ends 304A and 304B have been depicted as separately connected to the controller 302. Alternatively, two of the ends could be connected together so that the cofils 306A and 306B together represent a single current path.

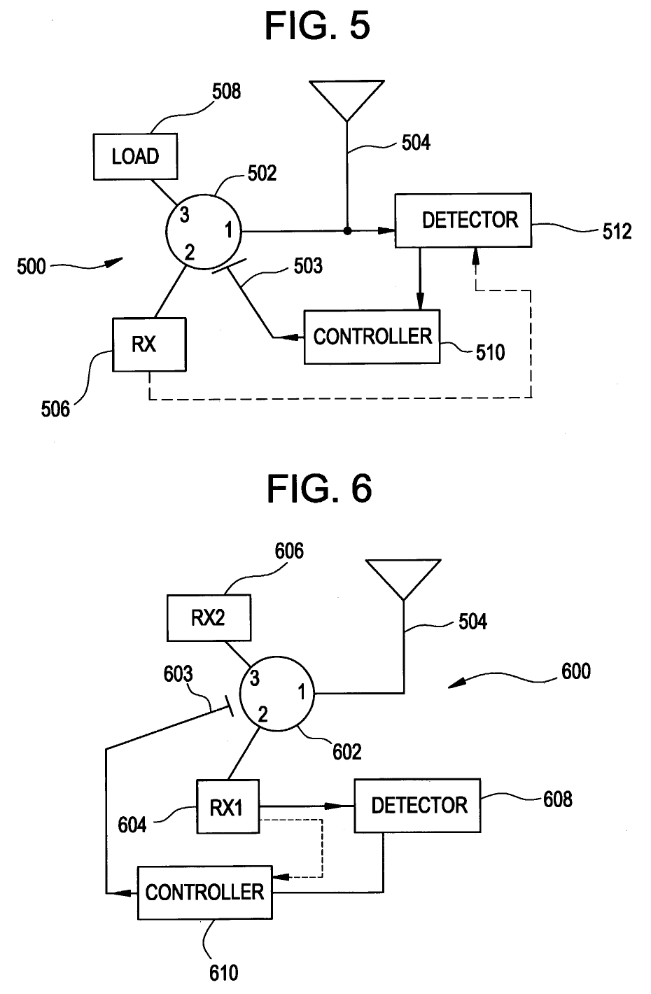

FIG. 5 is a circuit diagram depicting an example switchable circulator application according to an embodiment of the invention. An overload protection system 500 includes: a switchable circulator 502, e.g., similar to the switchable circulator 300; an RF receiving antenna 504 connected to port 1 of the circulator 502; an RF receiver 506 connected to port 2 of the circulator 502; a load 508, connected to port 3 of the circulator 502, substantially impedance-matched to the impedance of the launching disk, e.g., 102; a detector 512 connected to the antenna 504; and a controller 510 connected to the bias terminal 503 of the circulator 502 and the detector 512.

FIG. 6 is a circuit diagram of a switchable circulator application according to another embodiment of the invention. The redundant (or back-up) receiver system 600 includes: a switchable circulator 602; an RF receiving antenna 504 connected to port 1 of the circulator 602; a first RF receiver 604 connected to port 2 of the circulator 602; a second RF receiver 606 connected to port 3 of the circulator 602; a detector 608 connected to the receiver 604; and a controller 610 connected to the bias terminal 603 of the circulator 602 and to the detector 608.

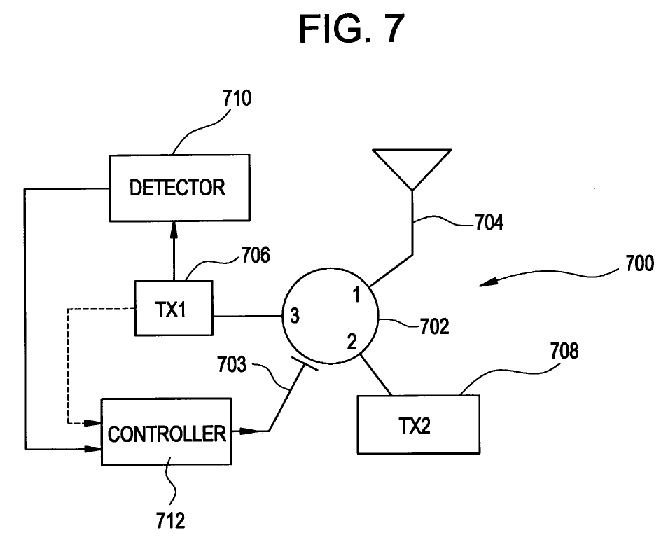

FIG. 7 depicts a circuit diagram of a switchable circulator application according to another embodiment of the invention. FIG. 7 is similar FIG. 6 except that it represents a redundant (or back-up) transmitter system rather than a redundant receiver system. The redundant transmitter system 700 includes: a switchable circulator 702; an RF transmitting antenna 704 connected to port 1 of the circulator 702; a first RF transmitter 706 connected to port 3 of the circulator 702; a second RF transmitter 708 connected to port 2 of the circulator 702; a detector 710 connected to the first transmitter 706; and a controller 712 connected to the bias terminal 703 of the circulator 702 and the detector 710.

The operation of the circuits depicted in FIGS. 5-7 will now be described.

In FIG. 5, the detector 512 determines the power of the RF signals received by the antenna 504. The detector 512 can be a simple diode circuit arrangement (not depicted). If the power of the signals from the antenna 504 exceeds a predetermined reference value, then the detector 512 provides an overload signal to the controller 510. The controller 510 then reverses the direction of the current to the electromagnets 306A and 306B to induce a magnetic field of opposite direction through the launching disk 102, which causes the direction of rotation in the circulator 502 to change from clockwise to counter-clockwise. As such, the overload signals will be switched so as not to pass from port 1 to port 2 of the circulator 402 but rather to pass from port 1 to port 3 of the circulator 502. Hence, the overload signals from the antenna 504 can be temporarily switched to the load 508 rather than to the receiver 506, thereby avoiding potential damage to the receiver 506.

The overload protection system can be helpful, e.g., in a circumstance in which the RF receiving antenna 504 is located in close proximity to a transmitting antenna (not depicted) exhibiting relatively intermittent operation, e.g., a paging antenna. When the adjacent paging antenna is not radiating, the signals provided by the antenna 504 do not exceed the power input capabilities of the receiver 506. But when the paging antenna (again, not depicted) pages/transmits, then the signals received by the antenna 504 can exceed the power input capabilities of the receiver 506. Hence, the system 500 can temporarily shunt the paging-induced overload from the receiver 506 to the load 508 due to the switchable rotation exhibited by the circulator 502 according to an embodiment of the invention.

FIGS. 5 and 6 depict (again) redundant back-up systems. In FIG. 6, the system is a receiver system while in FIG. 7 the system is a transmitter system. In both FIGS. 6 and 7, the detector 608/710 monitor the operation of the first receiver/transmitter 604/706. If a failure in the first receiver/transmitter 604/706 is determined, then the detector 608/710 provides a failure signal to the controller 610/712. In response, the controller 610/712 controls the electromagnets 306A, 306B to induce a magnetic field of opposite direction through the launching disk 102, thereby reversing the direction of rotation in the circulator 602/702.

In FIG. 6, the signals from the receiving antenna 504 are then directed to the back-up receiver 606. In FIG. 7, transmission signals from the back-up transmitter 708 are then connected to the transmitting antenna 704. Both the back-up systems of FIGS. 6 and 7 have the benefit of very little downtime between the failure of the first receiver/transmitter and the activation of the back-up receiver/transmitter, as compared to having to disconnect a field receiver/transmitter from a uni-directional circulator according to the Background Art and reconnecting a replacement receiver/transmitter.

Additional features and advantages of the invention will be more fully apparent from the following detailed description of example embodiments, the appended claims and the accompanying drawings.

We claim:

1. A circulator comprising:
a conductive launching disk;
at least two ferrite disks sandwiched about said launching disk; and
at least two electromagnets sandwiched about said ferrite disks.

2. The circulator of claim 1, wherein said electromagnets are electromagnetic coils.

3. The circulator of claim 1, further comprising:
a load substantially matched to the impedance of said launching disk;
wherein
said conductive launching disk has at least three ports;
said load is connected to one of said ports such that said circulator operates as an isolator.

4. The circulator of claim 1, further comprising:
a controller to selectively do at least one of:
control current flow through said electromagnets so as to induce
a first magnetic field through said launching disk resulting in a first direction of rotation or
a second magnetic field, substantially opposite to said first field, through said launching disk resulting in a second direction of rotation opposite to said first direction; and
substantially prevent current flow through said electromagnets so as to substantially prevent rotation through said launching disk.

5. The circulator of claim 4, wherein said first and second fields are substantially static after reaching equilibrium.

6. The circulator of claim 4, wherein said first and second fields are dynamic.

7. The circulator of claim 1, further comprising:
a conductive pole structure substantially enclosing said electromagnets, said ferrite disks and said launching disk.

8. A switching system comprising:
at least a first device, a second device and a third device;
a selectively switchable circulator having at least three ports connected to said first, second and third devices, respectively; and
a controller operable to change the rotation exhibited by said circulator.

9. The system of claim 8, wherein said controller is operable to monitor said first device for a predetermined condition and to change the rotation exhibited by said circulator upon detection of said predetermined condition.

10. The system of claim 9, wherein said controller is operable to do at least one of reverse the direction of rotation and substantially prevent rotation.

11. The system of claim 9, wherein
each of said first and second devices are receivers and said third device is an antenna,
a default state of said rotation direction of said circulator provides signals from said antenna to said first receiver;
said predetermined condition is a failure state of said first receiver; and
said controller is operable to change said rotation direction so that signals from said antenna go to said second receiver upon detection of failure in said first receiver.

12. The system of claim 9, wherein
each of said first and second devices are transmitters and said third device is an antenna,
a default state of said rotation direction of said circulator provides signals from said first transmitter to said antenna;
said predetermined condition is a failure state of said first transmitter; and
said controller is operable to change said rotation direction so that signals from said second transmitter go to said second antenna upon detection of failure in said first transmitter.

13. The system of claim 9, further comprising:
a threshold detector, operatively connected to said first device and said controller; operable to determine if signals provided by said antenna are greater than a reference value;
wherein
said second device is a receiver and said third device is a load;
a default state of said rotation direction of said circulator provides signals from said antenna to said receiver;
said controller is responsive to said detector and is operable to change said rotation direction so that signals from said antenna go to said load when the antenna signals exceed said reference value.

14. A circulator comprising:
a conductive launching disk;
a first ferrite disk adjacent to said launching disk;
a second ferrite disk adjacent to said launching disk and disposed on an opposite side of said launching disk relative to said first ferrite disk;
a first electromagnet adjacent to said first ferrite disk and disposed on an opposite side of said first ferrite disk relative to said launching disk; and
a second electromagnet adjacent to said second ferrite disk and disposed on an opposite side of said second ferrite disk relative to said launching disk.

15. The circulator of claim 14, wherein said electromagnets are electromagnetic coils.
